(19) United States
(12) Patent Application Publication
(10) Pub. No.: US 2026/0277913 A1
(43) Pub. Date: Sep. 17, 2026

(54) CUSTOM INTEGRATION PACKAGE GENERATION FOR IMPORTING DATA INTO A SYSTEM

(71) Applicant: Elastic Technologies (US) Inc., Wilmington (DE)

(72) Inventors: Eric Michael Beahan, Shawnee, KS (US); Jamie Hynds, Dungarvan (IE); Marius Iversen, Vellinge (SE); Sai Bharat Chandra Pasupula, Karlskrona (SE)

(21) Appl. No.: 19/464,220

(22) Filed: Jan. 29, 2026

Related U.S. Application Data
(60) Provisional application No. 63/751,081, filed on Jan. 29, 2025.

(51) Int. Cl. G06F 16/2457; G06F 16/242; G06F 16/26

(52) U.S. Cl. CPC G06F 16/24575; G06F 16/2425; G06F 16/26

(57) ABSTRACT

A system may receive, via an integration interface on a computing device, sample source data about a data stream. A system may generate a custom integration package by prompting a language model with at least the sample source data, where the custom integration package includes append processors configured to transform source data into a platform format. A system may initiate display of the custom integration package on the computing device.

### BACKGROUND

A security management system receives data from a variety of sources, detects threats, initiates an investigation incident, and/or performs actions to mitigate the impact of attacks. Some conventional security management systems have pre-configured integration packages that are used to convert source data into a common format. For some types of data, a custom integration package may have to be developed. However, creating a custom integration package can be technically challenging and/or time consuming.

### SUMMARY

In some aspects, the techniques described herein relate to a method including: receiving, via an integration interface on a computing device, sample source data about a data stream; generating a custom integration package by prompting a language model with at least the sample source data, the custom integration package including append processors configured to transform source data to a platform format; and initiating display of the custom integration package on the computing device.

In some aspects, the techniques described herein relate to an apparatus including: at least one processor; and a non-transitory computer-readable medium storing executable instructions that cause the at least one processor to execute operations, the operations including: receiving, via an integration interface on a computing device, sample source data about a data stream; generating a custom integration package by prompting a language model with at least the sample source data, the custom integration package including append processors configured to transform source data to a platform format; and initiating display of the custom integration package on the computing device.

In some aspects, the techniques described herein relate to a non-transitory computer-readable medium storing executable instructions that cause at least one processor to execute operations, the operations including: receiving, via an integration interface on a computing device, sample source data about a data stream; generating a custom integration package by prompting a language model with at least the sample source data, the custom integration package including append processors configured to transform source data to a platform format; and initiating display of the custom integration package on the computing device.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a security system that integrates a large language model (LLM) for generating a custom integration package using sample source data according to an aspect.

FIG. 1B illustrates an example of an integration package generator according to an aspect.

FIG. 1C illustrates an example of an integration package generator according to another aspect.

FIG. 1D illustrates an example of an integration package generator that executes a data structure to generate a first portion of a custom integration package according to an aspect.

FIG. 1E illustrates an example of an integration package generator that executes a data structure to generate a second portion of a custom integration package according to an aspect.

FIG. 1F illustrates an example of an integration package generator that executes a data structure to generate a third portion of a custom integration package according to an aspect.

FIG. 1G illustrates an example of a security system according to another aspect.

FIGS. 2A to 2J illustrate various examples of an integration interface for generating a custom integration package according to various aspects.

FIG. 3 illustrates an example of an architecture for generating an integration package according to an aspect.

FIG. 4 is a flowchart depicting example operations of a security system according to an aspect.

### DETAILED DESCRIPTION

This disclosure relates to an integration package generator configured to programmatically create a custom integration package for importing source data from a data source into a system. In some examples, the system is a security system. In some examples, the system is a management system. However, the system can be any type of computing system that receives, stores, and/or manages data from multiple data sources. The integration package generator includes, or is configured to communicate with, a language model (e.g., a large language model (LLM)) to analyze sample source data to generate and validate a custom integration package, which can be used to import source data that conforms to a platform format associated with the system. In some implementations, the system for generating an integration package includes or communicates with several artificial intelligence (AI) agents (e.g., LLMs or other AI agents), where each agent is trained for and/or configured to handle one or more steps of the operation. The integration package generator may automate the development of custom data integrations with generative artificial intelligence, which may reduce the effort to create and validate custom integrations and reduce the learning curve for onboarding data as compared with some conventional approaches. The integration package generator generates and validates a custom integration package that accurately maps raw data into platform fields and/or custom fields, determines event categorizations, and/or identifies/populates related fields. In some examples, the integration package generator may quickly parse, ingest, and create field mappings for data from sources without pre-configured ingestion packages.

A user may use a computing device to provide integration information (e.g., details on the data source) and to upload sample source data. The integration package generator generates one or more prompts with the sample source data. In some examples, the integration package generator generates a query (also referred to as a search query) based on the integration information and/or the sample source data and retrieves context data from a context database that is responsive to the query. The context data may include scheme data and/or index pattern data about a platform format and/or indexing scheme that are used by a platform such as a security analytics platform. However, the platform may be any type of server-based platform that can ingest, store, and/or manage data. In some examples, the prompt includes the context data. The integration package generator transmits the prompt to the language model, which returns a model response with at least a portion of the custom integration package. In some examples, the integration package generator may generate and transmit one or more other prompts to generate one or more other portions of the custom integration package. In some examples, the integration package generator iteratively constructs the custom integration package, e.g., iteratively generates and validates separate portions of the custom integration package. In some implementations, the integration package generator transmits the prompt to a primary agent (e.g. master agent) which assigns specific tasks to a plurality of sub agents that are configured to perform various tasks to generate an ingestion pipeline for generating the integration package.

In some examples, the integration package generator includes a validator (e.g., a validator tool) configured to validate the portions of the custom integration package, including whether the custom integration packages (or portion thereof) achieve one or more integration conditions. In some examples, the validator may communicate with the language model (or primary agent) to revise or adjust one or more portions of the custom integration packages so that invalidations and/or errors are reduced or eliminated. In some examples, the integration package generator may iteratively build, test, and/or adjust a custom integration package until the custom integration package satisfies the platform's integration conditions. In some examples, the integration package generator may adjust (e.g., fine-tune) the custom integration package in an automated feedback loop until the custom integration package is validated to achieve the integration condition(s) of the platform (e.g., a security analytics platform, management platform, or other type of platform). In some examples, the integration package generator may be used to add custom data sources faster than some conventional security analytics solutions and may facilitate broader visibility and easier security information and event management (SIEM) data implementation.

In some examples, a user can view the details of the custom integration package. In some examples, using the integration interface, the user may provide one or more adjustments to the custom integration package. After finalizing the integration, a user may initiate the addition of the custom integration package to a security agent installable on a security agent on a data source. In response to the custom integration package being deployed, the platform (e.g., a security analytics platform) can start analyzing the newly ingested data. Integration packages (e.g., pre-configured integration packages and/or custom integration packages generated by the integration package generator) normalize source data to the platform format (e.g., a common schema), which creates uniformity across dashboards, search, alerts, and/or machine learning.

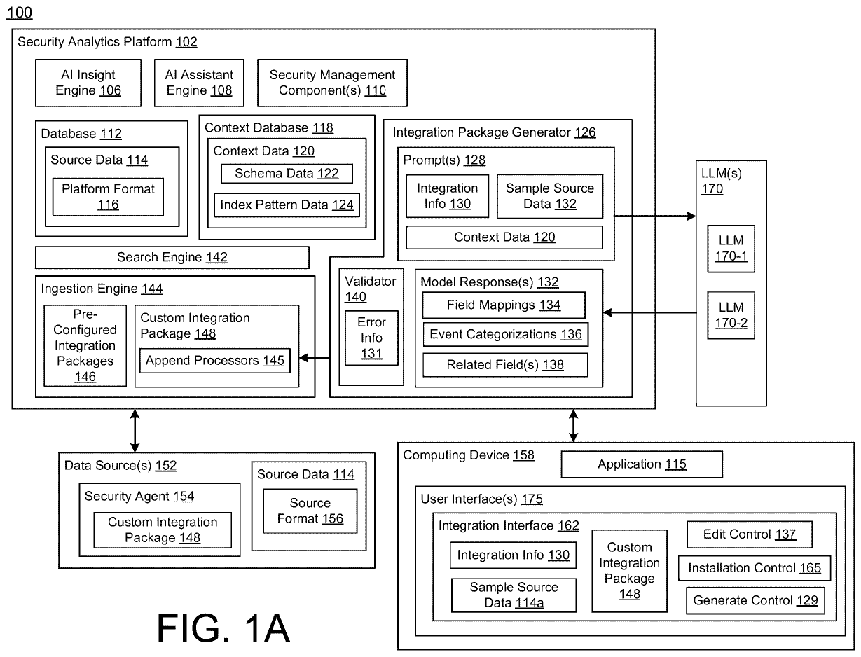

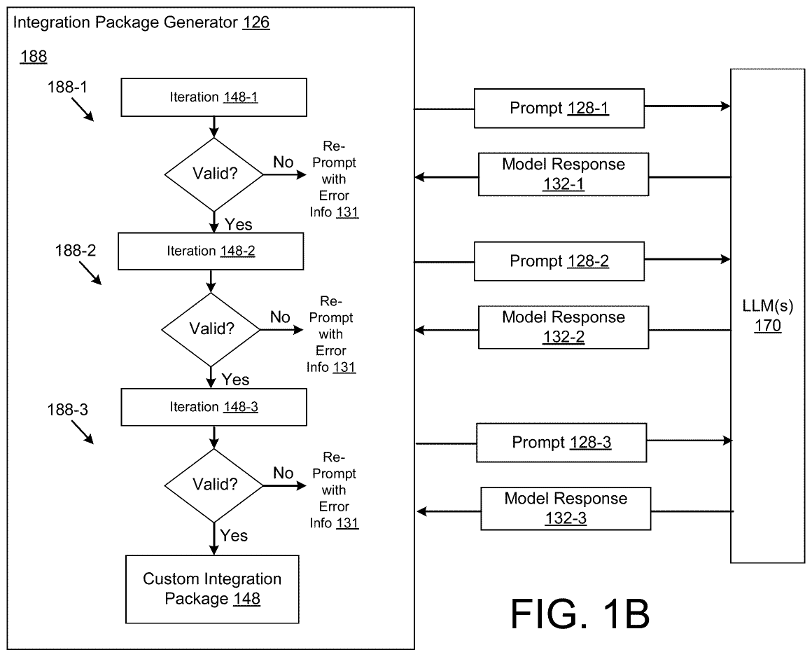

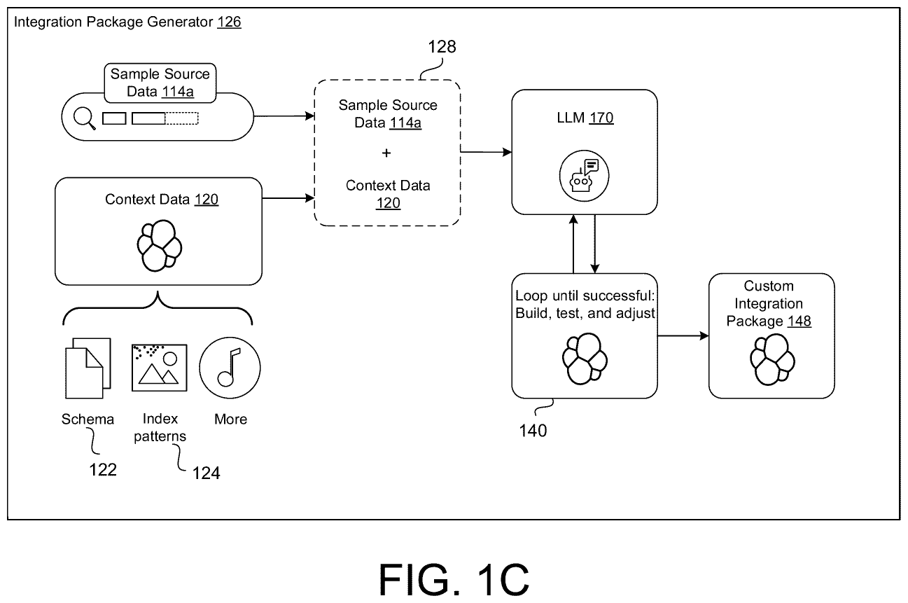

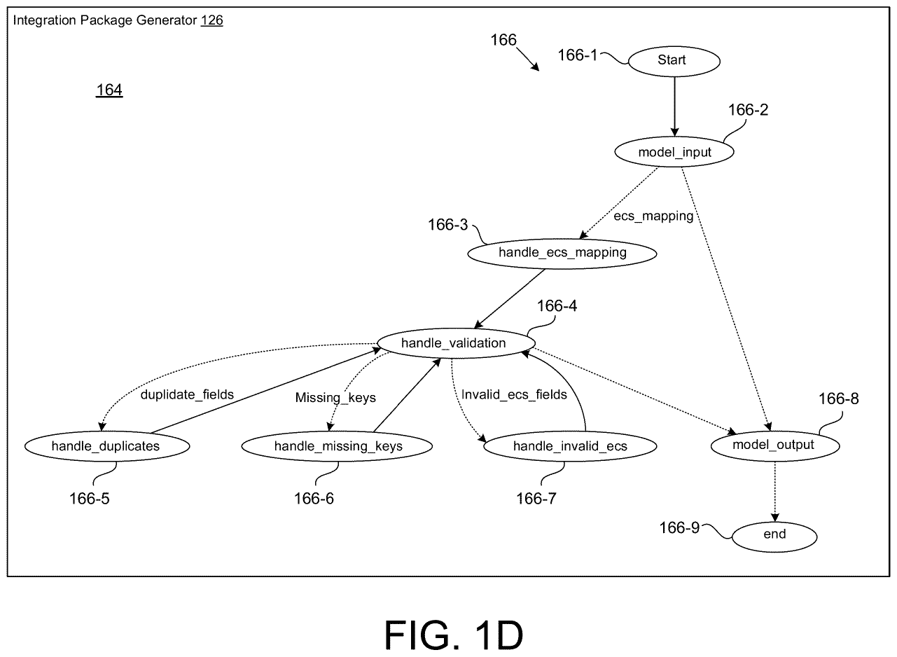

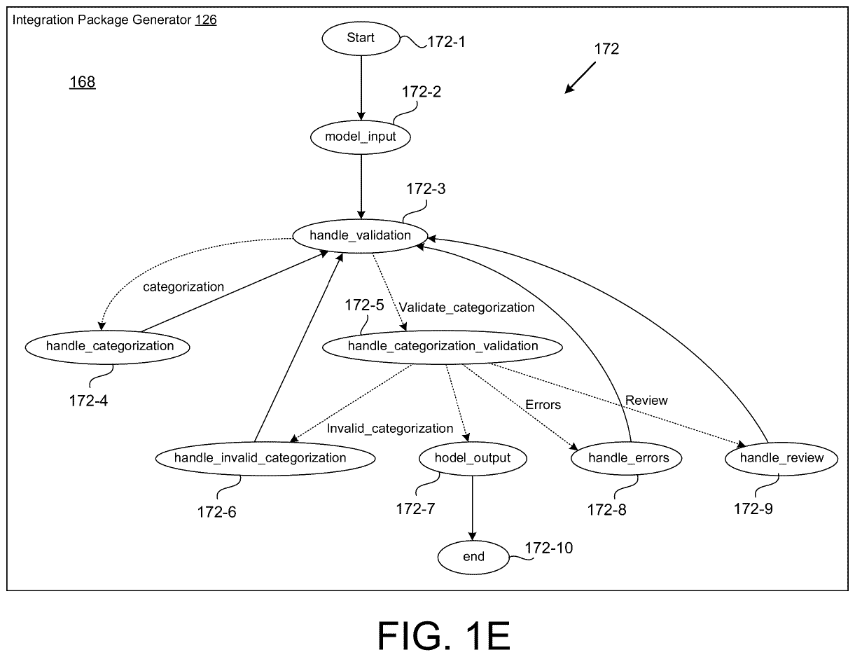

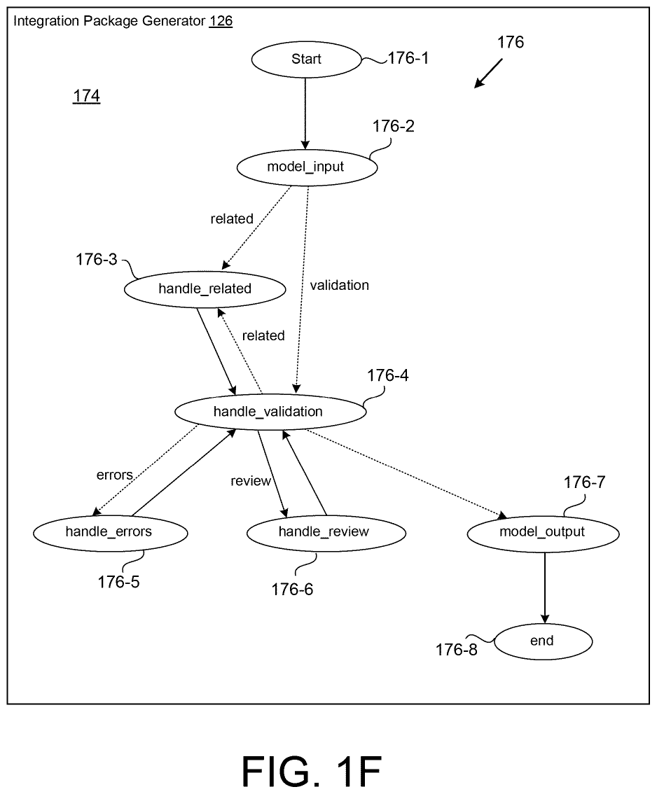

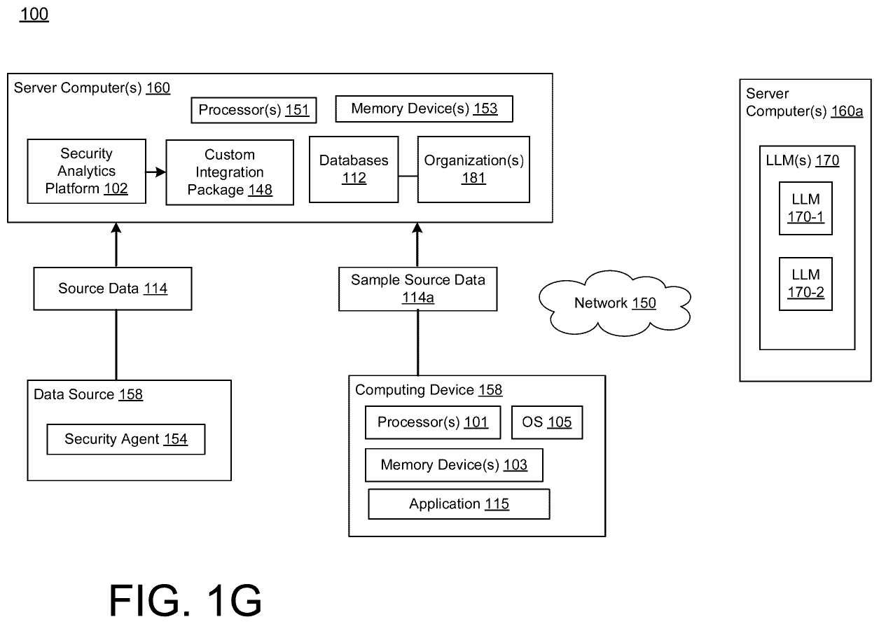

FIGS. 1A through 1G illustrate a system 100 that includes a platform 102 having an integration package generator 126 configured to communicate with a large language model (LLM) 170 to generate a custom integration package 148 for importing source data 114 from one or more data sources 152. In some implementations the LLM 170 includes a plurality of AI agents. In some examples, the system 100 is a security system. In some examples, the system 100 is a data management system. However, the system 100 may be any type of system that ingests, stores, and/or manages data. In some examples, the platform 102 includes a security analytics platform. In some examples, the source data 114 may be custom data for which a pre-configured integration package 146 is not compatible. However, a user can use a computing device 158 to initiate the integration package generator 126 to programmatically create a custom integration package 148 for importing the source data 114 into a database 112 of the platform 102.

The integration package generator 126 includes, or is configured to communicate with, an LLM 170 to analyze sample source data 114a to generate and validate a custom integration package 148, which can be used to convert the source data 114 in the source format 156 to the platform format 116. The integration package generator 126 may automate the development of custom data integrations with generative artificial intelligence (AI), which may reduce the effort to create and validate custom integrations and reduce the learning curve for onboarding data as compared with some conventional approaches. In some examples, the integration package generator 126 may quickly parse, ingest, and create field mappings 134, event categorizations 136, and/or related fields 138 without pre-configured ingestion packages 146.

The integration package generator 126 generates and validates a custom integration package 148 that accurately maps raw data (e.g., source data 114 in a source format 156) into source data 114 having the platform format 116. The source data 114 in the platform format 116 may be used with one or other components of the platform 102 such as an AI insight engine 106, an AI assistant engine 108, and/or one or more other components 110 (e.g., security management components) provided by the platform 102 (e.g., a security analytics platform, a data management platform, etc.).

In some examples, the integration package generator 126 is configured to communicate with one or more LLMs 170. For example, instead of integrating a single LLM 170 with the platform 102, the integration package generator 126 may be configured to operate with a plurality of different LLMs 170. In some examples, the integration package generator 126 includes connectors and an abstraction library. A connector may be a computer object that is stored at the platform 102 (e.g., a security analytics platform, a data management platform, etc.) and includes information that enables the integration package generator 126 to communicate with a corresponding LLM 170 (e.g., transmit a prompt 128, receive a model response 132). The abstraction library may define a library that generates a prompt 128 with a generic format that may be used by any of the LLMs 170 with connectors stored at the platform 102. The use of the connectors and/or the abstraction library may enable the integration package generator 126 to be agnostic to a plurality of LLMs 170. Although two LLMs 170 (e.g., LLM 170-1, LLM 170-2) are depicted in FIG. 1A, the integration package generator 126 may be configured to operate with any number of LLMs 170, including three, four, five, or any number greater than five. In some examples, the user may use the integration interface 162 to select a particular LLM 170 for use in generating the custom integration package 148. In some examples, the integration package generator 126 is configured to communicate with a primary LLM, which in turn communicates with a number of AI agents to generate the custom integration package 148.

A data source 152 is a component in a computing system. A data source 152 may be an end point (e.g., a user device such as workstation, smartphone, laptop, or wearable device, etc.), a network device (e.g., router, switch, or firewall), a server (e.g., an application server, a database server, or a web server), or an application (e.g., email server, a cloud service, a server application, or a client application). The source data 114 may be security-related data about system activity, network traffic, and/or security events. The source data 114 may include event data about security events about the data source(s) 152. The event data may encompass a wide variety of information such as a timestamp, source identifier, event type, message, user identifier, username, role, group, asset identifier, asset type location, operating system, source IP, destination IP, protocol, port, bytes, threat or alert identifier, threat type, and/or description, etc. The source data 114 may include information about login attempts, file access events, network traffic, and/or security alerts. The source data 114 may include configuration data about a state of a system, device, or an application. The configuration data may include user accounts, permissions, network settings, and/or security policy configurations. In some examples, the source data 114 is referred to as security information and event management (SIEM) data. However, the source data 114 may be any type of data, which may depend on the underlying system or platform.

A data source 152 includes a security agent 154. However, in some examples, the security agent 154 may be referred to as an agent, a data ingestion agent, or a client agent, etc. In some examples, the security agent 154 may be referred to as a network agent, an endpoint agent, an application agent, or a server-based agent. The security agent 154 is installed on a network device, server, or an endpoint from the platform 102. The security agent 154 is configured to perform data collection, data processing, data transmission, and/or policy enforcement. In some examples, the security agent 154 may monitor operations of the data source 152 and generate source data 114 for transmission to the platform 102. In some examples, the security agent 154 detects a security event on the data source 152 and generates and transmits the source data 114 when the security event is detected (or at a scheduled time). In some examples, the security agent 154 periodically generates the source data 114 (e.g., periodically generates configuration data about the data source 152). The security agent 154 may transmit, over a network 150, the source data 114 to the platform 102 for storage and/or analysis.

The security agent 154 may include a custom integration package 148 generated by the integration package generator 126. The security agent 154 may use the custom integration package 148 to convert the source data 114 from a source format 156 to a platform format 116 and then transmit the source data 114 in the platform format 116 to an ingestion engine 144 of the platform 102. The ingestion engine 144 may store the source data 114 in the platform format 116 in the database 112. In some examples, the ingestion engine 144 includes the custom integration package 148, where the ingestion engine 144 receives the source data 114 in the source format 156 and uses the custom integration package 148 to convert the source data 114 from the source format 156 to the platform format 116.

A custom integration package 148 (or a pre-configured integration package 146) may be referred to as an integration pipeline, a data pipeline, or a data integration process. A custom integration package 148 (or a pre-configured integration package 146) transforms (e.g., normalizes, converts, etc.) the source data 114 to a platform format 116 associated with the platform 102. Transforming the source data 114 from a source format 156 to a platform format 116 may include changing the names of data fields, adjusting the values of the data fields, removing information from the source data 114, and/or adding new information such as new data fields and/or values. In some examples, the source data 114 in the source format 156 may be referred to as raw data, unstructured data, and/or custom data. The source data 114 in the source format 156 may be in a scheme, format, or data structure associated with an organization's computing system. The platform format 116 may be a scheme, format, or data structure associated with the platform 102 and is common to other data stored in the database 112.

In some examples, the database 112 includes a vector database. A vector database is a database that stores data (e.g., data points) as vectors, where the vectors represent features or attributes of the data. For example, a vector database may represent data in vectors as opposed to organizing data in tables with rows and columns. In some examples, each dimension of the vector may correspond to a specific characteristic.

As shown in FIG. 1A, the system 100 includes a computing device 158. The computing device 158 may be a user device such as a laptop, desktop, smartphone, or generally any type of user device. The computing device 158 includes an application 115 configured to render a user interface 175 for one or more components of the platform 102. The user interface 175 includes an integration interface 162 that enables a user to generate a custom integration package 148 for importing source data 114 from a data source 152. In some examples, the integration interface 162 may receive sample source data 114a generated by the data source 152. For example, the user may use the integration interface 162 to submit the sample source data 114a. The sample source data 114a is in the source format 156. The sample source data 114a is an example or an instance of the source data 114 and may include any of the details discussed with reference to the source data 114. The sample source data 114a may be a file that includes event data or other types of source data 114. In some examples, the sample source data 114a may be a JavaScript Object Notation (JSON) file. However, the sample source data 114a may have other forms such as extensible markup language (XML), a comma-separated values (CVS), protocol buffers, or a type of specialized format.

In some examples, the user may use the integration interface 162 to select and/or enter integration information 130 about the source data 114. The integration information 130 includes details about the source data 114 and/or configuration settings of importing the source data 114. In some examples, the integration information 130 includes a title of the source data 114, a description of the source data 114, and/or a selected data collection method among a plurality of data collection methods.

In response to a selection of a generate control 129, the application 115 may transmit the sample source data 114a and the integration information 130 to the platform 102. In response to the sample source data 114a and the integration information 130, the integration package generator 126 may initiate the generation of a custom integration package 148. The integration package generator 126 may prompt the LLM 170 using the sample source data 114a, and, in some examples, the integration information 130, to generate one or more model responses 132 that define the custom integration package 148. In some examples, the integration package generator 126 may generate and transmit a prompt 128 to the LLM 170. The prompt 128 may include the sample source data 114a. In some examples, the prompt 128 includes the sample source data 114a and the integration information 130.

In some examples, the integration package generator 126 may retrieve context data 120 from a context database 118 and include the context data 120 in the prompt 128. In some examples, the context database 118 is a database that is separate from the database 112. In some examples, the context database 118 and the database 112 is a single database associated with an organization 181. In some examples, the context database 118 includes a vector database.

The context data 120 may include schema data 122 and index pattern data 124. The schema data 122 may be information about the platform format 116. The schema data 122 may include a model that defines the structure of data for the platform format 116. The schema data 122 may specify the fields, data types, and relationships between different data elements. The index pattern data 124 includes information (e.g., configuration settings or data) about an index structure generated by an ingestion engine 144. In some examples, the index pattern data 124 includes a template (e.g., a pattern) that defines how data is indexed by an ingestion engine 144. The index pattern data 124 may specify the fields that are indexed, the type of indexing to be used, and other configuration settings.

In some examples, in response to detection of the generate control 129, the integration package generator 126 may generate a query to retrieve context data 120 about the platform format 116, and then search and retrieve the context data 120 that is responsive to the query. In some examples, the integration package generator 126 may generate the query based on the integration information 130. In some examples, the integration package generator 126 may include the context data 120 in the prompt 128.

In response to the prompt 128, the LLM 170 generates a model response 132 with one or more portions (or all portions) of the custom integration package 148. The custom integration package 148 includes structured data that defines append processors 145 for converting the source data 114 from the source format 156 to the platform format 116. In some examples, the structured data that defines the append processors 145 may be JSON data. The append processor 145 may add new fields or values to existing data, enhance existing data (e.g., adding context or additional information), fill in missing or incomplete data, change titles or descriptions, perform transformations on existing data, and/or remove unnecessary data.

The append processors 145 may define field mappings 134, event categorizations 136, and/or related field(s) 138. The field mappings 134 may specify how data from one source (e.g., source 152) is mapped or transformed into corresponding fields in a target system (e.g., the database 112). In some examples, the field mappings 134 includes source fields (e.g., from the source format 156), target fields (e.g., in the platform format 116), and one or more mapping operations that define transformations applied to the source data 114 to the mapping process. The mapping operations may include renaming (e.g., changing the name of a field), data type conversion (e.g., converting data from one data type to another), value replacement, data extraction, aggregation, and/or filtering. The event categorizations 136 includes information about classifying security events. The event categorizations 136 may define event types and/or categories, event attributes (e.g., specific characteristics or properties associated with each event type and/or category), and/or event hierarchies that specify the relationships between different event types or categories. In some examples, the event categorizations 136 define one or more event fields (e.g., an event type, event category) and event attributes associated with each event field. The related field(s) 138 may be one or more new fields that capture information about each event type.

In some examples, a single model response 132 includes the field mappings 134, the event categorizations 136, and the related fields 138. For example, in response to the prompt 128, the LLM 170 may generate a model response 132 with the field mappings 134, the event categorizations 136, and the related fields 138. The integration package generator 126 includes a validator 140 configured to determine whether the field mappings 134, the event categorizations 136, and the related fields 138 are valid. Determining whether the field mappings 134, the event categorizations 136, and the related fields 138 are valid may include determining whether the field mappings 134, the event categorizations 136, and the related fields 138 satisfy one or more integration conditions. The integration conditions may include detecting that the custom integration package 148 is devoid of duplicate fields, missing keys, invalid fields, invalid categorizations, and/or errors. If the validator 140 detects that at least a portion of the custom integration package 148 is not valid, the validator 140 may generate error information 131 about the invalidation and the portion of the custom integration package 148 that failed. The integration package generator 126 may generate another prompt 128 with the error information 131 and the custom integration package 148 (or portion thereof), and in response, to the secondary prompt 128, the LLM 170 generates another model response 132 with a revised custom integration package 148 (or portion thereof).

After generation of the custom integration package 148, the integration package generator 126 may initiate the display of the custom integration package 148 for viewing on the computing device 158. The integration interface 162 may include an edit control 137. In response to the selection of the edit control 137, the application 115 may initiate the display of an editable version of the custom integration package 148, which can enable the user to adjust the append processors 145. In response to any user adjustments, the integration package generator 126 may perform a validation check to re-determine that the custom integration package 148 is valid. In some examples, the custom integration package 148 may be stored at the platform 102. In some examples, the integration interface 162 includes an installation control 165. In response to selection of the installation control 165, the platform 102 may initiate installation of the custom integration package 148 on a security agent 154 of a data source 152.

In some examples, the integration package generator 126 may iteratively generate and validate a portion of (e.g., each portion) and/or the entire the custom integration package 148. For example, the integration package generator 126 may iteratively build, test, and/or adjust a custom integration package 148 until the custom integration package 148 satisfies the platform's integration conditions. For example, as shown in FIG. 1B, the integration package generator 126 may execute a plurality of pipeline generation steps 188, where each pipeline generation step 188 generates and validates a different portion of the custom integration package 148. In some implementations, the integration package generator 126 utilizes multiple agents to generate and validate the entire custom integration package 148.

In a pipeline generation step 188-1, the integration package generator 126 may generate a prompt 128-1. In some examples, the prompt 128-1 includes the sample source data 114a. In some examples, the prompt 128-1 includes the sample source data 114a and the integration information 130. In some examples, the prompt 128-1 includes the sample source data 114a and the context data 120. In some examples, the integration package generator 126 retrieves context data 120 that relates to a portion of the custom integration package 148. In response to the prompt 128-1, the LLM 170 generates a model response 132-1, which is returned to the integration package generator 126. In some examples, the model response 132-1 includes a first portion (e.g., a subset) of the custom integration package 148. In some examples, the model response 132-1 includes the field mappings 134. Although field mappings 134 are used as part of the first portion, the first portion may include another portion of the custom integration package 148. The integration package generator 126 generates an iteration 148-1 (e.g., a first iteration) of the custom integration package 148, where the iteration 148-1 includes the first portion (e.g., the field mappings 134) of the custom integration package 148 that is included as part of the model response 132-1.

The integration package generator 126 determines whether the first portion of the custom integration package 148 is valid. Determining whether the second portion of the custom integration package 148 is valid may include determining whether the field mappings 134 satisfy one or more integration conditions. The integration conditions may include detecting that the field mappings 134 are devoid of duplicate fields, missing keys, invalid fields, and/or errors. If the integration package generator 126 detects that at least one field mapping 134 is not valid (No), the integration package generator 126 may generate error information 131 about the invalidation. The integration package generator 126 may generate a revised prompt with the error information 131 and the first portion of the custom integration package 148, and in response, to the revised prompt, the LLM 170 generates an updated model response with a revised iteration, which fixes (or attempts to fix) the error(s) detected during the pipeline generation step 188-1. The integration package generator 126 may re-determine whether the revised iteration is valid, and, if not, may transmit yet another revised prompt, and so forth until the first portion is validated.

In some examples, as shown in FIG. 1D, the integration package generator 126 executes a data structure 164 to generate and validate field mappings 134, which has been generated by the LLM 170. Although FIG. 1D illustrates field mappings 134, the data structure 164 may be applied to generate any one or more portions of a custom integration package 148. Execution of the data structure 164 performs the pipeline generation step 188-1 of FIG. 1B. The data structure 164 includes nodes 166 connected by directed edges. Each node 166 may relate to a different operation of the integration package generator 126 for generating the field mappings 134. In response to selection of the generate control 129, the process initiates at node 166-1, which causes the integration package generator 126 to initiate generation of the field mappings 134 of the custom integration package 148.

At node 166-2, the integration package generator 126 may retrieve and process the sample source data 114a for the prompt 128-1. In some examples, at node 166-2, the integration package generator 126 may filter and/or modify the sample source data 114a and merge the samples into a computer object (e.g., a single computer object). At node 166-3, the integration package generator 126 may communicate with the LLM 170 to generate the field mappings 134. At node 166-4, the integration package generator 126 determines whether the field mappings 134 are valid. If the field mappings 134 have at least one duplicate field, the process proceeds to node 166-5, which causes the integration package generator 126 to communicate with the LLM 170 to generate revised field mappings 134 to remove the duplicate field(s).

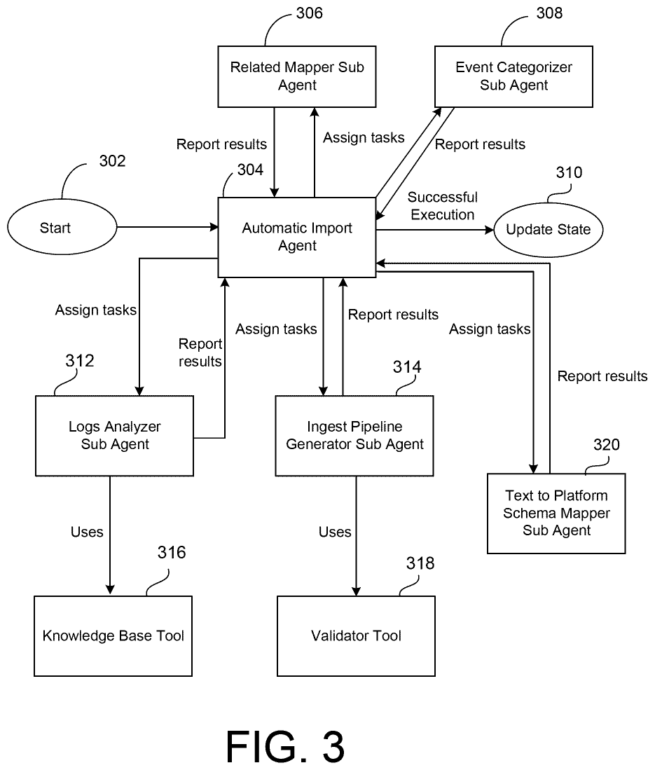

If the field mappings 134 have at least one missing key (e.g., a target field), the process proceeds to node 166-6, which causes the integration package generator 126 to communicate with the LLM 170 to generate revised field mappings 134 that fixes or removes the missing key(s). If the field mappings 134 have at least one invalid field, the process proceeds to node 166-7, which causes the integration package generator 126 to communicate with the LLM 170 to generate revised field mappings 134 that fixes or removes the invalid field(s). After execution of the operation at node 166-5, node 166-6, or node 166-7, the process returns to node 166-4 to perform another validation check. In response to a successful validation, the process proceeds to operation 166-8, which outputs the field mappings 134 and the process terminates at node 166-9. In some implementations, the process of generating and validating field mappings 134 is performed by using a primary agent and several subagents as further discussed below with respect to FIG. 3.

Referring back to FIG. 1B, in response to the first portion being determined as valid, in a pipeline generation step 188-2, the integration package generator 126 may generate an iteration 148-2 (e.g., a subsequent iteration) of the custom integration package 148 by prompting the LLM 170 with at least one of the sample source data 114a, the iteration 148-1, the integration information 130, or the context data 120. The iteration 148-2 may add a second portion (e.g., the event categorizations 136) to the custom integration package 148. Although the event categorizations 136 are used as the second portion, the second portion may include another portion of the custom integration package 148.

In the pipeline generation step 188-2, the integration package generator 126 may generate a prompt 128-2. In some examples, the prompt 128-2 includes the sample source data 114a and the iteration 148-1. In some examples, the prompt 128-1 includes the sample source data 114a, the integration information 130, and the iteration 148-1. In some examples, the prompt 128-1 includes the sample source data 114a, the iteration 148-1, and the context data 120. In some examples, in the pipeline generation step 188-2, the integration package generator 126 retrieves context data 120 that relates to a second portion of the custom integration package 148. In response to the prompt 128-2, the LLM 170 generates a model response 132-2, which is returned to the integration package generator 126. In some examples, the model response 132-2 includes the first portion (e.g., the field mappings 134) and a second portion (e.g., event categorizations 136). In other words, the LLM 170 may add the second portion (e.g., event categorizations 136) to the custom integration package 148. The integration package generator 126 generates the iteration 148-2 (e.g., the second iteration) of the custom integration package 148, where the iteration 148-2 includes the first portion (e.g., the field mappings 134) and the second portion (e.g., the event categorizations 136) of the custom integration package 148.

The integration package generator 126 determines whether the second portion of the custom integration package 148 is valid. Determining whether the second portion of the custom integration package 148 is valid may include determining whether the event categorizations 136 satisfy one or more integration conditions. The integration conditions may include detecting that the event categorizations 136 is devoid of invalid categorizations and/or errors. If the integration package generator 126 detects that the event categorizations 136 is not valid (No), the integration package generator 126 may generate error information 131 about the invalidation. The integration package generator 126 may generate a revised prompt with the error information 131 and the iteration 148-2, and in response, to the revised prompt, the LLM 170 generates an updated model response with a revised iteration, which fixes (or attempts to fix) the error(s) detected during the pipeline generation step 188-2. The integration package generator 126 may determine whether the revised iteration is valid, and, if not, may transmit yet another revised prompt.

In some examples, as shown in FIG. 1E, the integration package generator 126 executes a data structure 168 to generate and validate event categorizations 136, which has been generated by the LLM 170. Although FIG. 1E illustrates event categorizations 136, the data structure 168 may be applied to generate any one or more portions of a custom integration package 148. Execution of the data structure 168 performs the pipeline generation step 188-2 of FIG. 1B. The data structure 168 includes nodes 172 connected by directed edges. Each node 172 may relate to a different operation of the integration package generator 126 for generating or validating the event categorizations 136. In response to completion of the data structure 164, the process initiates at node 172-1, which causes the integration package generator 126 to initiate generation of the event categorizations 136 of the custom integration package 148.

At node 172-2, the integration package generator 126 may retrieve and process the sample source data 114a for the prompt 128-2. In some examples, at node 172-2, the integration package generator 126 may obtain the input for the prompt 128-2, such as the sample source data 114a, the field mappings 134, and/or the context data 120. At node 172-3, the integration package generator 126 determines whether the custom integration package 148 already includes the event categorizations 136, and, if so, the custom integration package 148 determines whether the event categorizations 136 are valid. If the custom integration package 148 does not include the event categorizations 136, the process proceeds to node 172-4. At node 172-4, the integration package generator 126 may communicate with the LLM 170 to generate the event categorizations 136. Then, the process returns to node 172-5. At node 172-5, the integration package generator 126 determines whether the event categorizations 136 are valid. In some examples, at node 172-5, if the integration package generator 126 determines that the process requires a user review, the process proceeds to node 172-9, which causes the integration package generator 126 to display information about the custom integration package 148.

If the event categorizations 136 have an invalid category, the process proceeds to node 172-6, which causes the integration package generator 126 to communicate with the LLM 170 to generate revised event categorizations 136 to correct the invalid category. If at least one of the event categorizations 136 has an error, the process proceeds to node 172-8, which causes the integration package generator 126 to communicate with the LLM 170 to generate revised event categorizations 136 that fixes or corrects the error. After execution of the operation at node 172-6 or node 172-8, the process returns to node 172-5 to perform another validation check. In response to a successful validation, the process proceeds to operation 172-7, which outputs the event categorizations 136 and the process terminates at node 172-10.

Referring back to FIG. 1B, in response to the second portion of the custom integration package 148 being determined as valid, in a pipeline generation step 188-3, the integration package generator 126 may generate an iteration 148-3 (e.g., a subsequent iteration) of the custom integration package 148 by prompting the LLM 170 with at least one of the sample source data 114a, the iteration 148-2 (e.g., the first and second portions), the integration information 130, and/or the context data 120. The iteration 148-3 may add a third portion (e.g., the related field(s) 138) to the custom integration package 148. Although the related field(s) 138 are used as the third portion, the third portion may include another portion of the custom integration package 148.

In the pipeline generation step 188-3, the integration package generator 126 may generate a prompt 128-3. In some examples, the prompt 128-3 includes the sample source data 114a and the iteration 148-2 (e.g., the first and second portions). In some examples, the prompt 128-3 includes the sample source data 114a, the integration information 130, and the iteration 148-2. In some examples, the prompt 128-3 includes the sample source data 114a, the iteration 148-2, and the context data 120. In some examples, in the pipeline generation step 188-3, the integration package generator 126 retrieves context data 120 that relates to the third portion of the custom integration package 148. In response to the prompt 128-3, the LLM 170 generates a model response 132-3, which is returned to the integration package generator 126. In some examples, the model response 132-3 includes the first portion (e.g., the field mappings 134), the second portion (e.g., event categorizations 136), and the third portion (e.g., related field(s) 138). In other words, the LLM 170 may add the third portion (e.g., the related field(s)) to the custom integration package 148. The integration package generator 126 generates the iteration 148-3 (e.g., the third iteration) of the custom integration package 148, where the iteration 148-3 includes the first portion (e.g., the field mappings 134), the second portion (e.g., the event categorizations 136), and third portion (e.g., the related field(s) 138) of the custom integration package 148.

In the pipeline generation step 188-3, the integration package generator 126 determines whether the third portion of the custom integration package 148 is valid. Determining whether the third portion of the custom integration package 148 is valid may include whether the related field(s) 138 satisfy one or more integration conditions. The integration conditions may include detecting that the related field(s) 138 is devoid of invalid categorizations and/or errors. If the integration package generator 126 detects that the related field(s) 138 is not valid (No), the integration package generator 126 may generate error information 131 about the invalidation. The integration package generator 126 may generate a revised prompt with the error information 131 and the iteration 148-3, and in response, to the revised prompt, the LLM 170 generates an updated model response with a revised iteration, which fixes (or attempts to fix) the error(s) detected during the pipeline generation step 188-3. The integration package generator 126 may determine whether the revised iteration is valid, and, if not, may transmit yet another revised prompt. Although FIG. 1B illustrates three pipeline generation steps 188, the integration package generator 126 may perform any number of pipeline generation steps 188, including two steps or any number greater than three. The integration package generator 126 may also perform concurrent steps and/or may use multiple agents to generate the pipeline.

In some examples, as shown in FIG. 1F, the integration package generator 126 executes a data structure 174 to generate and validate related fields 138, which has been generated by the LLM 170. Although FIG. 1F illustrates related fields 138, the data structure 174 may be applied to generate any one or more portions of a custom integration package 148. Execution of the data structure 174 performs the pipeline generation step 188-3 of FIG. 1B. The data structure 174 includes nodes 176 connected by directed edges. Each node 176 may relate to a different operation of the integration package generator 126 for generating or validating the related fields 138. In response to completion of the data structure 168, the process initiates at node 176-1, which causes the integration package generator 126 to initiate generation of the related fields 138 of the custom integration package 148.

At node 176-2, the integration package generator 126 may retrieve and process the sample source data 114a for the prompt 128-3. In some examples, at node 176-2, the integration package generator 126 may obtain the input for the prompt 128-3, such as the sample source data 114a, the field mappings 134, the event categorizations 136 and/or the context data 120. At node 176-3, the integration package generator 126 may communicate with the LLM 170 to generate the related fields 138. Then, the process proceeds to node 176-4. At node 176-4, the integration package generator 126 determines whether the related fields 138 are valid. In some examples, at node 176-4, if the integration package generator 126 determines that the process requires a user review, the process proceeds to node 176-6, which causes the integration package generator 126 to display information about the custom integration package 148.

If the related fields 138 has an error, the process proceeds to node 176-5, which causes the integration package generator 126 to communicate with the LLM 170 to generate revised related fields 138 to correct the error. After execution of the operation at node 176-6, the process returns to node 176-4 to perform another validation check. In response to a successful validation, the process proceeds to operation 176-7, which outputs the related fields 138 and the process terminates at node 176-8.

Referring back to FIG. 1A, the source data 114 in the database 112 may be used by one or more components of the platform 102 such as an AI insight engine 106, an AI assistant engine 108, a search engine 142, and/or other security management component(s) 110. For example, the AI assistant engine 108 may provide a chat interface configured to receive user prompts (e.g., user queries) for an LLM 170. The AI assistant engine 108 may operate with a LLM 170 to assist a user with tasks like writing queries, understanding security events or alerts, and/or troubleshooting issues. In some examples, the AI assistant engine 108 receives a user prompt and generates a query based on the user prompt. The AI assistant engine 108 may use the query to search for and retrieve information (e.g., source data 114 in the platform format 116) and may include that information as contextual data in the prompt provided to the LLM 170.

The AI insight engine 106 operates with an LLM 170 to identify active attacks in the computing system, without the time (or prior experience) required to manually investigate individual security alerts. In some examples, an AI insight engine 106 may be referred to as an attack discovery engine. The AI insight engine 106 may use the source data 114 in the platform format 116 to identify whether one or more of the security events or alerts are related, and, in some examples, the AI insight engine 106 may document the identified attack progression.

During data ingestion, the ingestion engine 144 may persist the source data 114 and/or one or more index structures about the source data 114 to storage (e.g., the database 112). The database 112 may be stored on a server computer 160, as shown in FIG. 1G. In some examples, the ingestion engine 144 may generate one or more index structures about the source data 114. An index structure may be a data structure that includes information about the source data 114 that has been indexed. In some examples, an index structure is referred to as an index, a Lucene index (e.g., Lucene files) or segments (e.g., Lucene segments) or a stateless compound commit file.

The search engine 142 may search the index structure(s) for responsive data in the database 112 and/or the context database 118 that are responsive to the search query. In some examples, the integration package generator 126 uses the search engine 142 to retrieve context data 120 for the prompt(s) 128. For example, the search engine 142 may receive or generate search term(s) and obtain the relevant search results by searching the index structure(s). In some examples, the search engine 142 may rank the search results.

In some examples, the search engine 142 may retrieve, in response to a search query, a set of semantically similar results according to one or more search strategies. Using the search strategies discussed herein, search results may include a set of semantically similar results that are relevant (e.g., highly relevant) to the search query. The search strategies may include a vector database search, a natural language processing (NLP) enrichment search, a late interaction model search, and/or a regular token matching search. In some examples, the search engine 142 uses a hybrid search that uses a combination of two or more of the following search strategies: a vector database search, an NLP enrichment search, a late interaction model search, and/or a regular token matching search.

The computing device 158 may be any type of computing device that includes one or more processors 101, one or more memory devices 103, and an operating system 105 configured to execute (or assist with executing) an application 115. In some examples, the application 115 includes a browser application. The application 115 may be a program configured to communicate with the platform 102. In some examples, the application 115 is a native application installable on the operating system 105. In some examples, the application 115 is a web application executable by a browser application. In some examples, the application 115 is a web page executable by a browser application. In some examples, the user interface(s) 175 is/are interfaces of the platform 102, which may include the integration interface 162. In some examples, the computing device 158 is a laptop computer. In some examples, the computing device 158 is a desktop computer. In some examples, the computing device 158 is a tablet computer. In some examples, the computing device 158 is a smartphone. In some examples, the computing device 158 is a wearable device (e.g., a head-mounted display device such as an augmented reality (AR) or a virtual reality (VR) device).

The processor(s) 101 may be formed in a substrate configured to execute one or more machine executable instructions or pieces of software, firmware, or a combination thereof. The processor(s) 101 can be semiconductor-based-that is, the processors can include semiconductor material that can perform digital logic. The memory device(s) 103 may include a main memory that stores information in a format that can be read and/or executed by the processor(s) 101. The memory device(s) 103 may store the operating system 105, including the application 115 that, when executed by the processors 101, performs certain operations discussed with reference to the application 115 or the computing device 158 discussed herein. In some examples, the memory device(s) 103 store one or more portions of the platform 102 that, when executed by the processors 101, performs certain operations discussed with reference to the platform 102. In some examples, the memory device(s) 103 includes a non-transitory computer-readable medium that includes executable instructions that cause at least one processor (e.g., the processors 101) to execute the operations discussed herein.

The server computer 160 may be computing devices that take the form of a number of different devices, for example a standard server, a group of such servers, or a rack server system. The server computer 160 may represent a single server computer or multiple server computer. In some examples, the server computer 160 may represent multiple server computers that are in communication with each other. In some examples, the server computer 160 may be a single system sharing components such as processors and memories. In some examples, the server computer 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within the network. The network 150 may further include any number of hardwired and/or wireless connections.

The server computer(s) 160 may include one or more processors 151 formed in a substrate, an operating system (not shown) and one or more memory devices 153. The memory device(s) 153 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 151 may be formed in a substrate configured to execute one or more machine executable instructions or pieces of software, firmware, or a combination thereof. The processor(s) 151 can be semiconductor-based-that is, the processors can include semiconductor material that can perform digital logic. The memory device(s) 153 may store information in a format that can be read and/or executed by the processor(s) 151. The memory device(s) 153 may store one or more portions of the platform 102, that, when executed by the processor(s) 151, perform certain operations discussed herein. In some examples, the memory device(s) 153 includes a non-transitory computer-readable medium that includes executable instructions that cause at least one processor (e.g., the processor(s) 151) to execute operations.

The LLM 170 may include any type of pre-trained LLM configured to generate a model response 132 in response to a prompt 128. In some examples, the LLM 170 is stored on a server computer 160a that is separate from the server computer 160 that hosts the platform 102. The server computer 160a may be server computing resources that are owned and/or managed by an entity that is separate from an entity that owns and/or manages the server computer 160. In some examples, the LLM 170 is a third-party LLM that is not managed or owned by the system 100. In some examples, the LLM 170 is a predefined LLM that is managed or owned by the system 100. In some examples, the LLM 170 is stored on the server computer 160 that hosts the platform 102. In some examples, the LLM 170 includes several different LLMs or AI agents.

The LLM 170 includes weights. The weights are numerical parameters that the LLM 170 learns during the training process. The weights are used to compute the output (e.g., the model response 132) of the LLM 170. The LLM 170 may receive the prompt 128 from the integration package generator 126. The LLM 170 includes a pre-processing engine configured to pre-process the information in the prompt 128. Pre-processing may include converting the textual input of the prompt 128 to individual tokens (e.g., words, phrases, or characters). Pre-processing may include other operations such as removing stop words (e.g., “the”, “and”, “of”) or other terms or syntax that do not impart any meaning to the LLM 170. The LLM 170 includes an embedding engine configured to generate word embeddings from the pre-processed text input. The word embeddings may be vector representations that assist the LLM 170 to capture the semantic meaning of the input tokens and may assist the LLM 170 to better understand the relationships between the input tokens.

The LLM 170 includes neural network(s) configured to receive the word embeddings and generate an output. A neural network includes multiple layers of interconnected neurons (e.g., nodes). The neural network may include an input layer, one or more hidden layers, and an output later. The output may include a sequence of output word probability distributions, where each output distribution represents the probability of the next word in the sequence given the input sequence so far. In some examples, the output may be represented as a probability distribution over the vocabulary or a subset of the vocabulary. The neural network(s) is configured to receive the word embeddings and generate an output, and, in some examples, the query activity (e.g., previous natural language queries and textual responses). The output may represent a version of the model response 132. The output may include a sequence of output word probability distributions, where each output distribution represents the probability of the next word in the sequence given the input sequence so far. In some examples, the output may be represented as a probability distribution over the vocabulary or a subset of the vocabulary. The decoder is configured to receive the output and generate the model response 132. In some examples, the decoder may select the most likely instruction, sampling from a probability distribution, or using other techniques to generate coherent and well written model response 132.

In some examples, the database 112 and/or context database 118 may be stored on a server computer 160 that also includes, or is associated with an entity that also manages, the platform 102. In some examples, the database 112 and/or the context database 118 is external to the server computer 160 that hosts the platform 102. In other words, in some examples, the database 112 is owned and/or managed by an entity that is different from the entity that owns and/or manages the platform 102. In some examples, the database 112 may be an external data store.

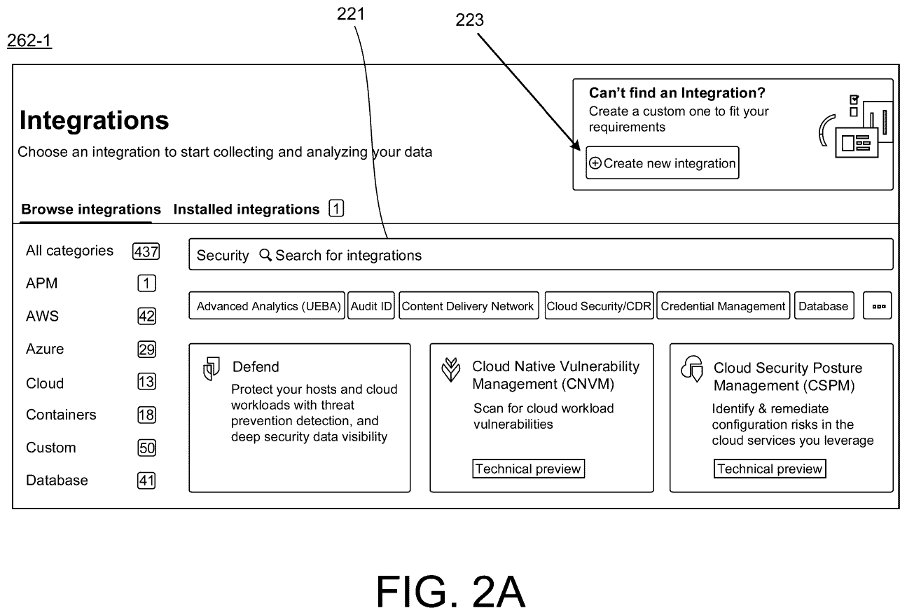

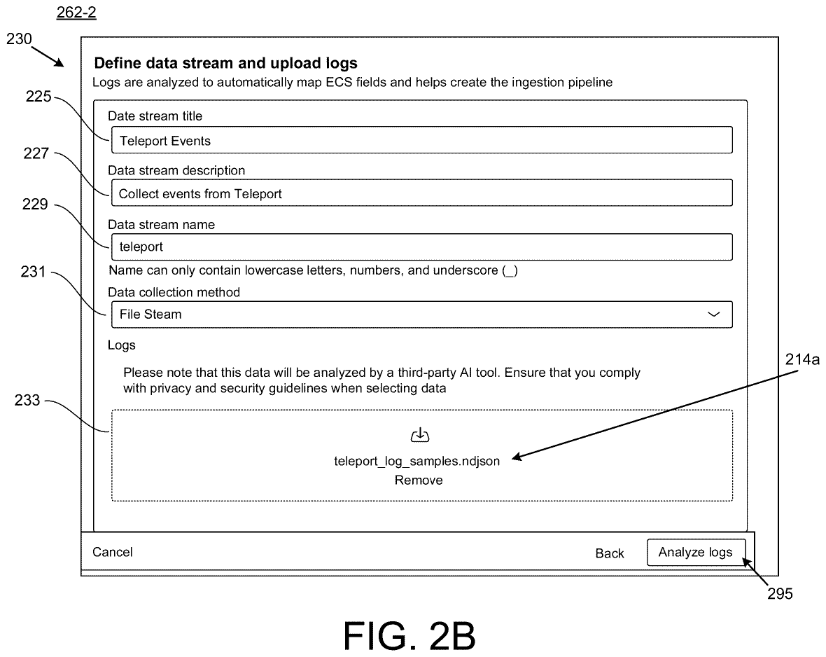

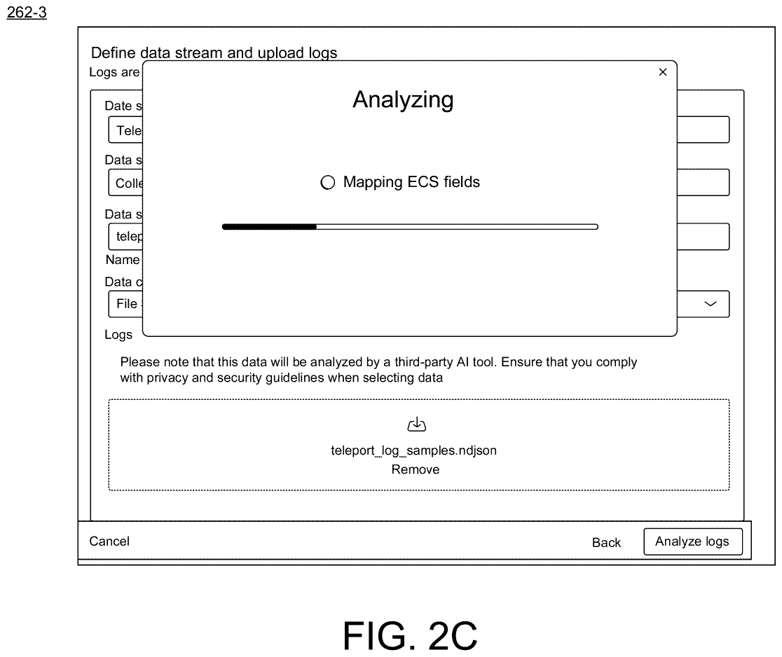

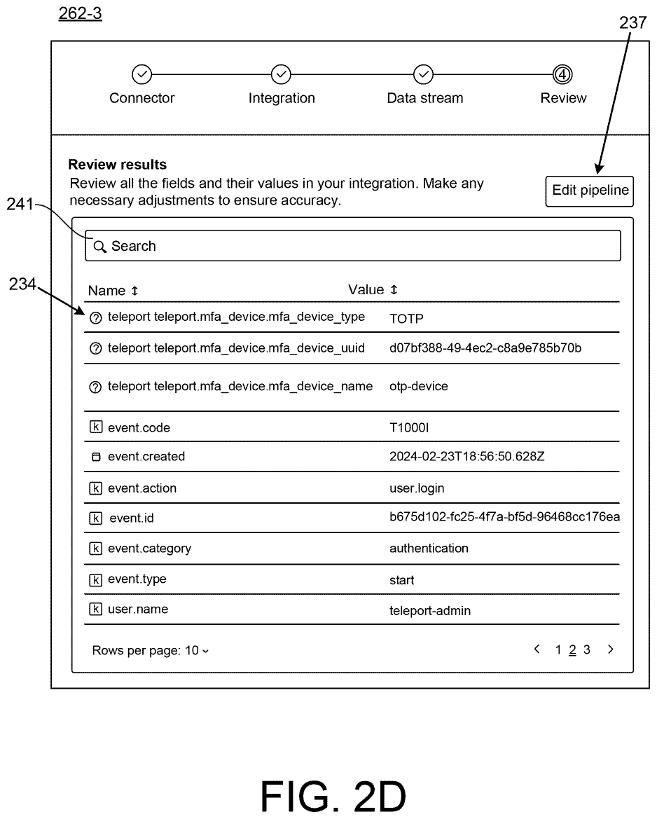

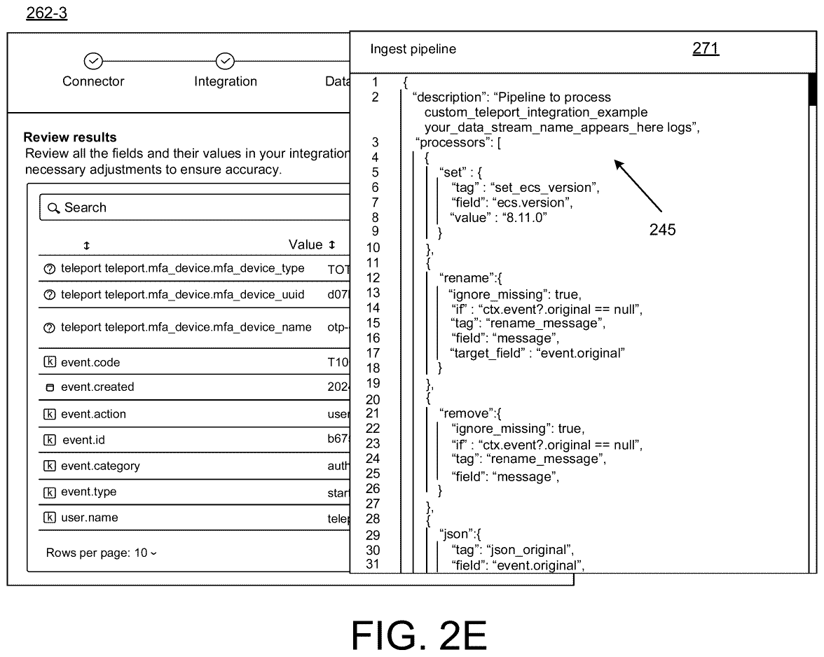

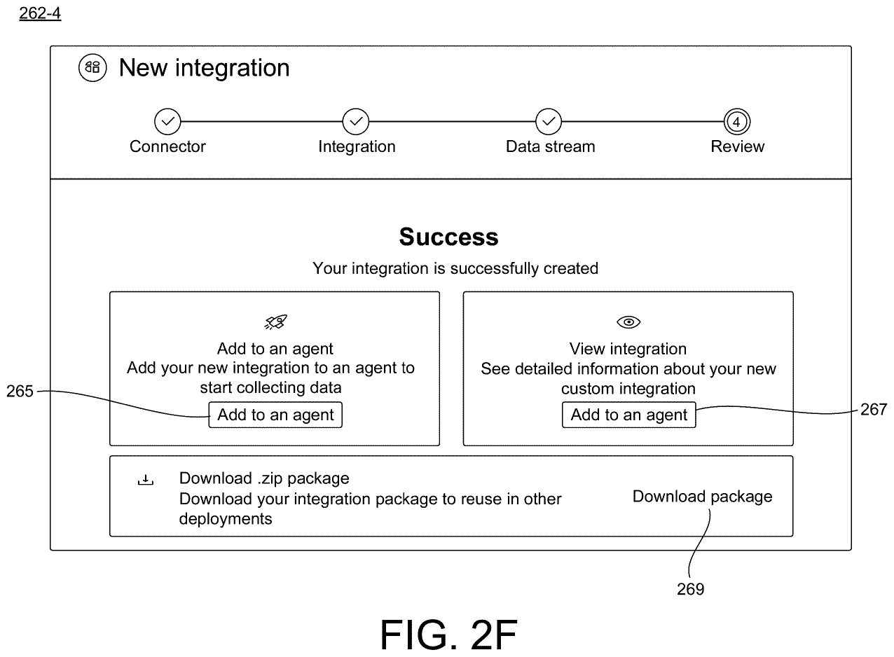

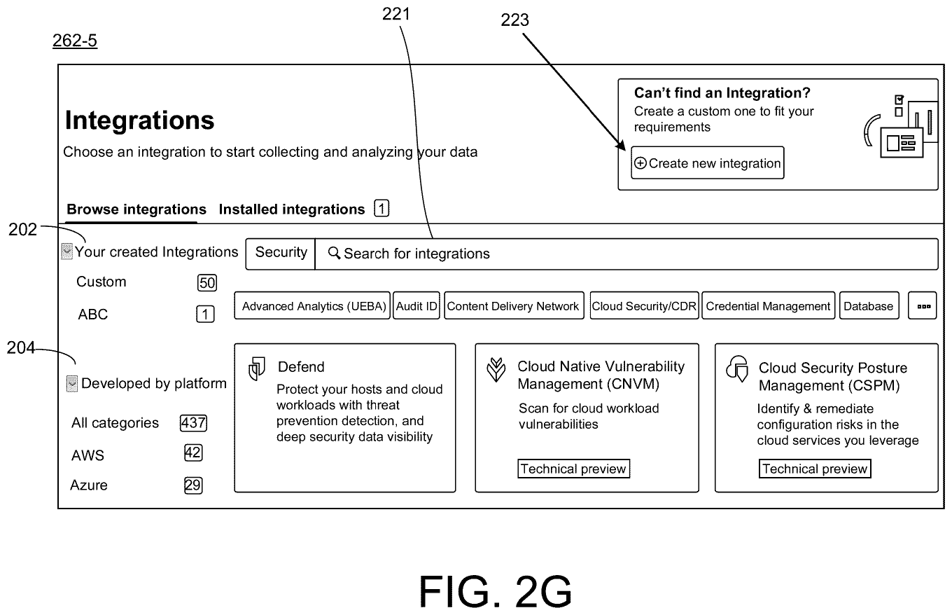

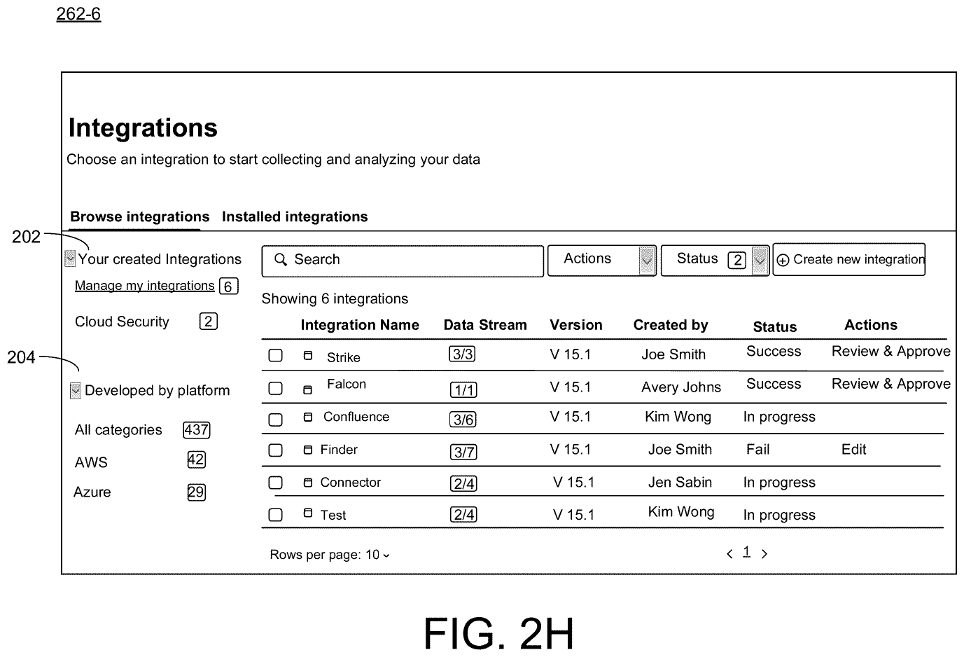

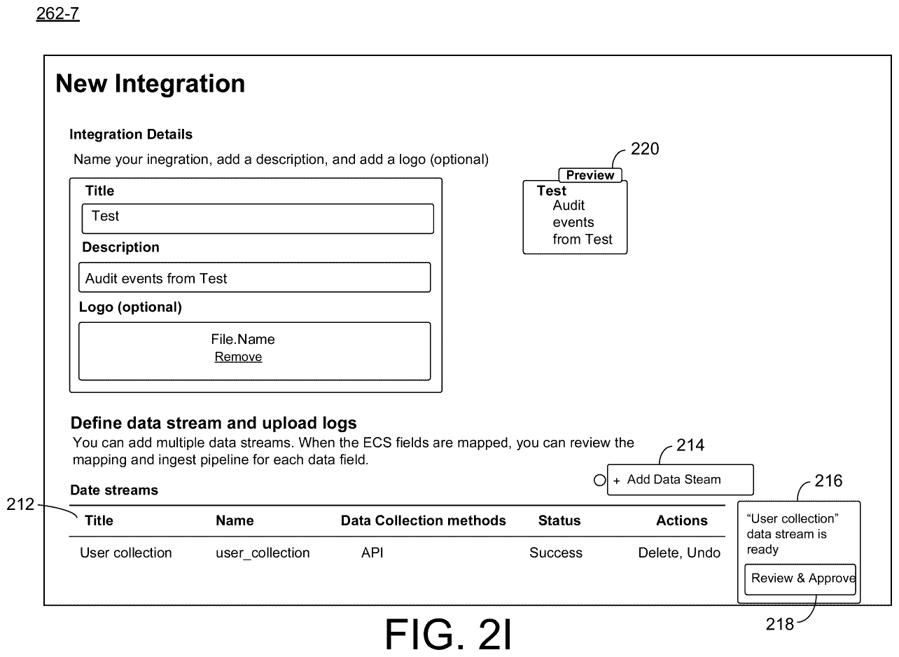

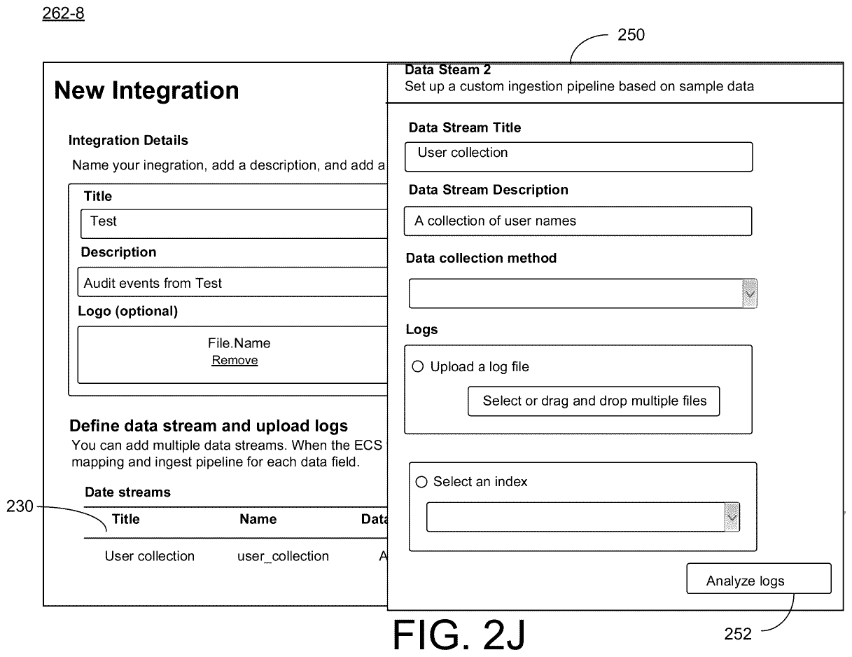

FIG. 2A to 2J illustrate various examples of integration interfaces for creating a custom integration package. The integration interfaces of FIGS. 2A to 2J may be an example of the integration interface 162 of FIGS. 1A to 1G and may include or operate according to the description as discussed with reference to FIGS. 1A to 1G. 148. Referring to FIG. 2A, an integration interface 262-1 includes a search field 221 that enables a user to search for pre-configured integration packages. The integration interface 262-1 includes a create control 223, which, in some examples, when selected, causes an application (e.g., the application 115) to display an integration interface 262-2 of FIG. 2B. In FIG. 2B, the integration interface 262-2 enables the user to select or enter integration information 230 (e.g., the integration information 130 of FIGS. 1A to 1G). The integration information 230 may include a title 225, a description 227, a stream name 229, and a selected data collection method 231. The integration interface 262-2 of FIG. 2B also includes a field 233 (or a control) that enables the user to add sample source data 214a (e.g., the sample source data 114a of FIGS. 1A to 1G).

In response to a selection of a generate control 295, the integration package generator 126 of FIGS. 1A to 1G may initiate generation of a custom integration package 234, and, while the custom integration package 234 is generated, the application may display an integration interface 262-3 of FIG. 2C. After the custom integration package 234 is generated, the application displays an integration interface 262-3, shown in FIG. 2D, with the custom integration package 234, where a user can view the target fields and values for the samples. The integration interface 262-3 may include a search field 241 that enables the user to search for information within the custom integration package 234. The integration interface 262-3 includes an edit control 237, which, when selected, causes the application to render an editable version 271 of the custom interaction package 234, as shown in FIG. 2E. As shown in FIG. 2E, the user can view the append processors 245 generated by the LLM 170. After viewing and/or approving, the application displays an integration interface 262-4, depicted in FIG. 2F, that indicates that the custom integration package 234 has successfully been created. The integration interface 262-4 includes an installation control 265, which, when selected, causes the custom integration package 234 to be added to a security agent. The integration interface 262-4 includes a view control 267, which, when selected, causes the application to display detailed information about the new custom integration. The integration interface 262-4 may include a download control 269, which, when selected, causes the application to download the custom integration package 234.

In some implementations, an integration interface 262-5 of FIG. 2G may be used to enable a user to search for pre-configured integration packages. The integration interface 262-5 includes many of the user interface elements of the integration interface 262-1 of FIG. 2A. Furthermore, the integration interface 262-1 enables a user to browse for user created integrations (e.g., user specific integrations) via a user interface portion 202 and browse separately for integrations developed by the platform using a user interface portion 204.

In some examples, when a category of integration is selected from the user generated integrations or platform developed integrations, an application (e.g., application 115) displays an integration interface 262-6 of FIG. 2H which may display information about the integrations that fall into the selected category. The information may include the integration name, number of data streams, version, the name of the person who created the integration, status of the integration and/or actions available for the integration. In some examples, when an integration from the displayed list is selected (e.g., by clicking on the name or checking the check box displayed next to the name of the integration, a user interface element may be displayed that presents a list of actions available for the integration (e.g., review and approve, download, edit, delete, etc.).

In some examples, when the create control 223 of FIG. 2G or FIG. 2A is selected, an application (e.g., the application 115) displays an integration interface 262-7 of FIG. 2I. In FIG. 2I, the integration interface 262-7 enables the user to provide details about the new integration such as a title, description or logo. In some examples, the integration interface 262-7 also includes the control 214 which enables the user to add a data stream to the new integration. Upon selecting the control 214, the fields displayed in FIG. 2B which enable the user to enter data for the new data streams may be displayed. The integration interface 262-7 depicts an already added data stream which includes integration information 212 which may include a title, name, data collection method, status of the data stream and actions available for the data stream (e.g., undo a latest action or delete the data stream). The integration interface 262-7 may also display a user interface element 216 that indicates a data stream was successfully added, upon which the user may select a control 218 to review and approve the data stream. In some examples, the integration interface 262-7 also includes a user interface element 220 that enables the user to preview the new integration.

In some implementations, upon selecting the control 214 to add a data stream, an integration interface 262-8 of FIG. 2J is displayed. The integration interface 262-8 displays a user element portion 250 (which may be overlayed on the integration interface 262-7 of FIG. 2H) to enable the user to enter information about the new data stream. The information may include a data stream title, description, data collection method (which may be selectable from a drop-down menu), logs (which may be uploaded from one or more files, and/or an index (which may also be selected from a drop-down menu). Once the information is provided, the user may select the control 252 to enable the system to analyze the logs for the new data stream.

FIG. 3 illustrates an example of an architecture for generating an integration package according to an aspect. The architecture depicted in FIG. 3 provides an alternative implementation of the integration package generator which utilizes a multi-agent orchestration framework. In this aspect, the system employs a primary agent and several specialized sub-agents to automate the research, generation, and/or validation of the custom integration package. As depicted, the architecture employs a multi-agent system which includes the automatic import Agent 304 and a plurality of specialized sub-agents to programmatically construct and validate a custom integration package.

The process of generating an integration package may start at a start node 302 and move to the automatic import agent 304, which may serve as a primary agent and operate as a research agent and orchestrator. The automatic import agent 304 may have access to multiple sub-agents, which are available to it as tools to perform standalone tasks. The automatic import agent 304 may be self-sufficient, managing the workflow from the start node 302 through to a successful update state 310 once the task is complete. The process begins at the start node 302, where the automatic import agent 304 initiates the workflow, manages the sequence of operations, and concludes with the update state 310 upon successful execution.

The automatic import agent 304 assigns tasks to and receives results from multiple sub-agents which may include a logs analyzer sub agent 312, knowledge base tool 316, related mapper sub agent 306, event categorizer sub agent 308, ingest pipeline generator sub agent 314, validator tool 318 and text to platform schema mapper sub agent 320. For example, if the automatic import agent 304 receives the prompt “generate an ingest pipeline for the integrationId ‘foo’”, the agent 304 may call the logs analyzer sub agent 312 to provide the necessary summary information about the samples from the user. After receiving the summary information, the automatic import agent 304 may call the ingest pipeline generator sub agent 314 to generate a working pipeline for the samples and logs summary. The automatic import agent 304 may then send a request to the text to platform schema mapper sub agent 320 to generate the mappings for the unique fields in the pipeline. The pipeline generator 314 may add rename processors to the mappings. The automatic import agent 304 may then send a request to the event categorizer sub agent 308 and related mapper sub agent 306 to provide the necessary fields to the ingest pipeline generator sub agent 314 to add append processors to the pipeline. Finally, a working pipeline is generated and updated back into the state at node 310.

The logs analyzer sub agent 312 may be a standalone agent that analyzes the sample source data received in the input. The logs analyzer sub agent 312 may receive a request and provide detailed information about the data format, variations, and/or a breakdown of field types. The knowledge base tool 316 may be a generic LLM used by the logs analyzer sub agent 312 to provide the latest documentation regarding platform-specific schemas (such as ECS) and ingest processors.

The text to platform schema mapper sub agent 320 may provide corresponding platform-standard fields (e.g., ECS fields) for the input text field names, along with a confidence level for each mapping. This enables the system to directly map input text to platform-standard fields. The event categorizer sub agent 308 may provide event categorization information, such as event type and event category. The related mapper sub agent 306 may identify related field information such as related IP, related hosts, related user, and related hash.

Once the various sub agents analyze the sample source data, provide platform-specific schemas, provide event categorization information and/or identify related field information, the ingest pipeline generator sub agent 314 generates a working ingestion pipeline based on the input fields. The generated ingestion pipeline may then be transmitted to the validator tool 318 to validate the quality of the generated pipeline against the input samples to ensure correct parsing. When the validator successfully validates the ingestion pipeline, a message may be transmitted to the automatic import agent 304 which initiates a process for updating the state.

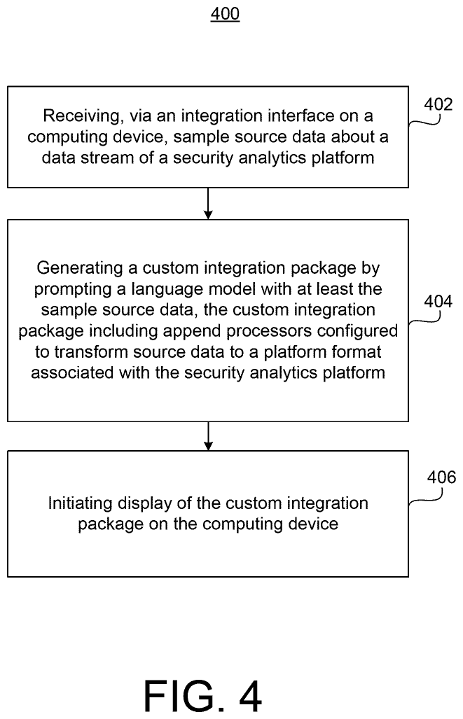

FIG. 4 is a flowchart 400 depicting example operations of a system for generating a custom integration package, which, when deployed, can facilitate the ingestion of data into the system's database, where the data has a format that is common to the platform's format. The system may be a security analytics system, a data management system, or any type of system that receives, stores, and/or manages data collected from multiple data sources. The example operations of FIG. 4 may be executed by the system 100 of FIGS. 1A to 1G, or system depicted in FIG. 3 and may be used to generate any of the user interfaces shown in FIGS. 2A to 2J. The flowchart 400 may depict operations of a computer-implemented method or a non-transitory computer-readable medium. Although the flowchart 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion.

Operation 402 includes receiving, via an integration interface on a computing device, sample source data about a data stream. Operation 404 includes generating a custom integration package by prompting a language model with at least the sample source data, the custom integration package including append processors configured to transform source data into a platform format. Operation 406 includes initiating display of the custom integration package on the computing device.

Clause 1. A method comprising: receiving, via an integration interface on a computing device, sample source data about a data stream; generating a custom integration package by prompting a language model with at least the sample source data, the custom integration package including append processors configured to transform source data to a platform format; and initiating display of the custom integration package on the computing device.

Clause 2. The method of clause 1, further comprising: in response to a selection of an edit control on the integration interface, initiating display of an editable version of the custom integration package.

Clause 3. The method of clause 1, further comprising: in response to selection of an installation control, initiating installation of the custom integration package on an agent executable by a data source.

Clause 4. The method of clause 1, further comprising: receiving, via one or more input fields of the integration interface, integration information about the data stream; and generating the custom integration package by prompting the language model with at least the integration information and the sample source data.

Clause 5. The method of clause 4, further comprising: in response to receiving the sample source data, retrieving context data from a context data store, the context data including at least one of scheme data or index pattern data; and generating the custom integration package by prompting the language model with at least the integration information, the sample source data, and the context data.

Clause 6. The method of clause 1, wherein generating the custom integration package includes: generating a first iteration of the custom integration package by prompting the language model with the sample source data; determining whether the first iteration is valid; in response to the first iteration being determined is valid, generating a second iteration of the custom integration package by prompting the language model with the sample source data and the first iteration; determining whether the second iteration is valid; and in response to the second iteration being determined is valid, determining the second iteration as the custom integration package or initiating generation of a third iteration of the custom integration package.

Clause 7. The method of clause 6, wherein generating the custom integration package includes: in response to the first iteration being determined as not valid, re-generating the first iteration by prompting the language model with the sample source data and error information.

Clause 8. The method of clause 1, wherein generating the custom integration package includes: transmitting, to the language model, a first prompt with the sample source data; receiving, from the language model, a first model response with field mappings; determining whether the field mappings are valid; and in response to the field mappings being determined is valid, generating a first iteration with the field mappings.

Clause 9. The method of clause 8, wherein generating the custom integration package includes: transmitting, to the language model, a second prompt with the sample source data and the field mappings; receiving, from the language model, a second model response with event categorizations; determining whether the event categorizations is valid; and in response to the event categorizations being determined as valid, generating a second iteration with the field mappings and the event categorizations.

Clause 10. The method of clause 9, wherein generating the custom integration package includes: transmitting, to the language model, a third prompt with the sample source data, the field mappings, and the event categorizations; receiving, from the language model, a third model response with a related field for an event type; determining whether the related field is valid; and in response to the related field being determined as valid, generating a third iteration with the field mappings, the event categorizations, and the related field.

Clause 11. An apparatus comprising: at least one processor; and a non-transitory computer-readable medium storing executable instructions that cause the at least one processor to execute operations, the operations comprising: receiving, via an integration interface on a computing device, sample source data about a data stream; generating a custom integration package by prompting a language model with at least the sample source data, the custom integration package including append processors configured to transform source data to a platform format; and initiating display of the custom integration package on the computing device.

Clause 12. The apparatus of clause 11, wherein the operations comprise: in response to a selection of an edit control on the integration interface, initiating display of an editable version of the custom integration package.

Clause 13. The apparatus of clause 11, wherein the operations comprise: in response to selection of an installation control, initiating installation of the custom integration package on an agent executable by a data source.

Clause 14. The apparatus of clause 11, wherein the operations comprise: receiving, via one or more input fields of the integration interface, integration information about the data stream; in response to receiving the sample source data, retrieving context data from a context data store, the context data including at least one of scheme data or index pattern data; and generating the custom integration package by prompting the language model with at least the integration information, the sample source data, and the context data.

Clause 15. The apparatus of clause 11, wherein the operations comprise: generating a first iteration of the custom integration package by prompting the language model with the sample source data; determining whether the first iteration is valid; in response to the first iteration being determined as valid, generating a second iteration of the custom integration package by prompting the language model with the sample source data and the first iteration; in response to the first iteration being determined as not valid, re-generating the first iteration by prompting the language model with the sample source data and error information; determining whether the second iteration is valid; and in response to the second iteration being determined as valid, determining the second iteration as the custom integration package or initiating generation of a third iteration of the custom integration package.

Clause 16. The apparatus of clause 11, wherein the language model communicates with a plurality of sub agents to generate the custom integration package, the plurality of sub agents including at least one of a logs analyzer, knowledge base tool, related mapper, text to platform schema mapper, event categorizer, pipeline generator and a validator.

Clause 17. A non-transitory computer-readable medium storing executable instructions that cause at least one processor to execute operations, the operations comprising: receiving, via an integration interface on a computing device, sample source data about a data stream; generating a custom integration package by prompting a language model with at least the sample source data, the custom integration package including append processors configured to transform source data to a platform format; and initiating display of the custom integration package on the computing device.

Clause 18. The non-transitory computer-readable medium of clause 17, wherein the operations comprise: in response to a selection of an edit control on the integration interface, initiating display of an editable version of the custom integration package.

Clause 19. The non-transitory computer-readable medium of clause 17, wherein the operations comprise: in response to selection of an installation control, initiating installation of the custom integration package on an agent executable by a data source.

Clause 20. The non-transitory computer-readable medium of clause 17, wherein the operations comprise: receiving, via one or more input fields of the integration interface, integration information about the data stream; in response to receiving the sample source data, retrieving context data from a context data store, the context data including at least one of scheme data or index pattern data; and generating the custom integration package by prompting the language model with at least the integration information, the sample source data, and the context data.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
receiving, via an integration interface on a computing device, sample source data about a data stream;
generating a custom integration package by prompting a language model with at least the sample source data, the custom integration package including append processors configured to transform source data to a platform format; and
initiating display of the custom integration package on the computing device.

2. The method of claim 1, further comprising:
in response to a selection of an edit control on the integration interface, initiating display of an editable version of the custom integration package.

3. The method of claim 1, further comprising:
in response to selection of an installation control, initiating installation of the custom integration package on an agent executable by a data source.

4. The method of claim 1, further comprising:
receiving, via one or more input fields of the integration interface, integration information about the data stream; and
generating the custom integration package by prompting the language model with at least the integration information and the sample source data.

5. The method of claim 4, further comprising:
in response to receiving the sample source data, retrieving context data from a context data store, the context data including at least one of scheme data or index pattern data; and
generating the custom integration package by prompting the language model with at least the integration information, the sample source data, and the context data.

6. The method of claim 1, wherein generating the custom integration package includes:
generating a first iteration of the custom integration package by prompting the language model with the sample source data;
determining whether the first iteration is valid;
in response to the first iteration being determined as valid, generating a second iteration of the custom integration package by prompting the language model with the sample source data and the first iteration;
determining whether the second iteration is valid; and
in response to the second iteration being determined as valid, determining the second iteration as the custom integration package or initiating generation of a third iteration of the custom integration package.

7. The method of claim 6, wherein generating the custom integration package includes:
in response to the first iteration being determined as not valid, re-generating the first iteration by prompting the language model with the sample source data and error information.

8. The method of claim 1, wherein generating the custom integration package includes:
transmitting, to the language model, a first prompt with the sample source data;
receiving, from the language model, a first model response with field mappings;
determining whether the field mappings are valid; and
in response to the field mappings being determined as valid, generating a first iteration with the field mappings.

9. The method of claim 8, wherein generating the custom integration package includes:
transmitting, to the language model, a second prompt with the sample source data and the field mappings;
receiving, from the language model, a second model response with event categorizations;
determining whether the event categorizations is valid; and
in response to the event categorizations being determined as valid, generating a second iteration with the field mappings and the event categorizations.

10. The method of claim 9, wherein generating the custom integration package includes:
transmitting, to the language model, a third prompt with the sample source data, the field mappings, and the event categorizations;
receiving, from the language model, a third model response with a related field for an event type;
determining whether the related field is valid; and
in response to the related field being determined as valid, generating a third iteration with the field mappings, the event categorizations, and the related field.

11. An apparatus comprising:
at least one processor; and
a non-transitory computer-readable medium storing executable instructions that cause the at least one processor to execute operations, the operations comprising:
receiving, via an integration interface on a computing device, sample source data about a data stream;
generating a custom integration package by prompting a language model with at least the sample source data, the custom integration package including append processors configured to transform source data to a platform format; and
initiating display of the custom integration package on the computing device.

12. The apparatus of claim 11, wherein the operations comprise:
in response to a selection of an edit control on the integration interface, initiating display of an editable version of the custom integration package.

13. The apparatus of claim 11, wherein the operations comprise:
in response to a selection of an installation control, initiating installation of the custom integration package on an agent executable by a data source.

14. The apparatus of claim 11, wherein the operations comprise:
receiving, via one or more input fields of the integration interface, integration information about the data stream;
in response to receiving the sample source data, retrieving context data from a context data store, the context data including at least one of scheme data or index pattern data; and
generating the custom integration package by prompting the language model with at least the integration information, the sample source data, and the context data.

15. The apparatus of claim 11, wherein the operations comprise:
generating a first iteration of the custom integration package by prompting the language model with the sample source data;
determining whether the first iteration is valid;
in response to the first iteration being determined as valid, generating a second iteration of the custom integration package by prompting the language model with the sample source data and the first iteration;
in response to the first iteration being determined as not valid, re-generating the first iteration by prompting the language model with the sample source data and error information;
determining whether the second iteration is valid; and
in response to the second iteration being determined as valid, determining the second iteration as the custom integration package or initiating generation of a third iteration of the custom integration package.

16. The apparatus of claim 11, wherein the language model communicates with a plurality of sub agents to generate the custom integration package, the plurality of sub agents including at least one of a logs analyzer, knowledge base tool, related mapper, text to platform schema mapper, event categorizer, pipeline generator and a validator.

17. A non-transitory computer-readable medium storing executable instructions that cause at least one processor to execute operations, the operations comprising:
receiving, via an integration interface on a computing device, sample source data about a data stream;
generating a custom integration package by prompting a language model with at least the sample source data, the custom integration package including append processors configured to transform source data to a platform format; and
initiating display of the custom integration package on the computing device.

18. The non-transitory computer-readable medium of claim 17, wherein the operations comprise:
in response to a selection of an edit control on the integration interface, initiating display of an editable version of the custom integration package.

19. The non-transitory computer-readable medium of claim 17, wherein the operations comprise:
in response to a selection of an installation control, initiating installation of the custom integration package on an agent executable by a data source.

20. The non-transitory computer-readable medium of claim 17, wherein the operations comprise:
receiving, via one or more input fields of the integration interface, integration information about the data stream;
in response to receiving the sample source data, retrieving context data from a context data store, the context data including at least one of scheme data or index pattern data; and
generating the custom integration package by prompting the language model with at least the integration information, the sample source data, and the context data.
